(19) United States
(12) Patent Application Publication
(10) Pub. No.: US 2026/0342192 A1
(43) Pub. Date: Oct. 29, 2026

(54) LINEAR VIBRATION MOTOR

(71) Applicant: AAC Microtech (Changzhou) Co., Ltd., Changzhou City (CN)

(72) Inventors: Yun Tang, Changzhou (CN); Lubin Mao, Changzhou (CN); Wei Song, Changzhou (CN); Zhiyong Cui, Changzhou (CN)

(21) Appl. No.: 19/305,778

(22) Filed: Aug. 21, 2025

Related U.S. Application Data
(63) Continuation of application No. PCT/CN2025/090835, filed on Apr. 24, 2025.

(51) Int. Cl. H02K 33/02

(52) U.S. Cl. CPC H02K 33/02

(57) ABSTRACT

The present disclosure discloses a linear vibration motor including a housing, a vibrator including two magnet assemblies spaced apart from each other and arranged in parallel, a stator including a coil located between the two magnet assemblies, and an elastic member configured to suspend the vibrator in the housing. The coil is spaced apart from each of the two magnet assemblies along a first direction perpendicular with a vibration direction of the vibrator. A winding plane of the coil is parallel to the vibration direction. Two opposite ends of the coil along a second direction are fixed on housing. The second direction is orthogonal to the vibration direction and the first direction. The linear vibration motor in the present disclosure has higher drive efficiency.

### FIELD OF THE PRESENT DISCLOSURE

The present disclosure relates to vibration technologies, especially relates to a linear vibration motor applied in portable mobile terminals.

### DESCRIPTION OF RELATED ART

Linear vibration motor provides haptic effects for portable mobile terminals such as mobile phone and gamepad.

Generally, the linear vibration motor includes a housing, a vibrator for vibrating, a stator for driving the vibrator, and an elastic member for guiding the movement of the vibrator. Magnet and coil are adopted to provide drive force for the vibrator.

In related art, the magnet is located on one side of the coil, and the winding plane of the coil is perpendicular with the vibration direction of the vibrator. However, only one side of the coil is interacted with the magnet. In this manner, the driving force may not be sufficiently utilized, thus reducing the drive efficiency of the linear vibration motor.

Therefore, it is necessary to provide an improved linear vibration motor to overcome the problems mentioned above.

### SUMMARY OF THE INVENTION

One object of the present disclosure is to provide a linear vibration motor with higher drive efficiency.

The linear vibration motor includes a housing, including: a bottom plate; and an upper cover disposed on the bottom plate to form a receiving space; a vibrator received in the receiving space, including two magnet assemblies spaced apart from each other and arranged in parallel; a stator mounted on the bottom plate and configured to drive the vibrator to vibrate along a vibration direction, including a coil located between the two magnet assemblies; and an elastic member configured to suspend the vibrator in the receiving space; wherein the coil is spaced apart from each of the two magnet assemblies along a first direction perpendicular with the vibration direction; a winding plane of the coil is parallel to the vibration direction; two opposite ends of the coil along a second direction are fixed on the bottom plate and the upper cover respectively; the second direction is orthogonal to the vibration direction and the first direction.

As an improvement, the upper cover includes an upper plate opposite to the bottom cover along the second direction, and a side wall connected the bottom plate and the upper plate; the coil is sandwiched between the bottom plate and the upper plate.

As an improvement, the coil is glued to the bottom plate and the upper plate.

As an improvement, a width of the coil along the vibration direction is smaller than a width of each of the two magnet assemblies along the vibration direction.

As an improvement, the width of the coil along the vibration direction is smaller than a height of the coil along the second direction.

As an improvement, the number of the elastic member is two; the two elastic members are located at two opposite sides of the vibrator along the vibration direction respectively; two ends of each of the two elastic members are fixed on the vibrator and the side wall respectively.

As an improvement, the vibrator further includes a mass block including a through hole penetrating thereon along the second direction; the two magnet assemblies are mounted on the mass block and received in the through hole; two ends of each of the two elastic members are fixed on the mass block and the side wall respectively.

As an improvement, the vibrator further includes two yokes; each of two yokes is sandwiched between a respective one of the two magnet assemblies and the mass block.

As an improvement, each of the two magnet assemblies includes three magnets arranged successively along the vibration direction to form a Halbach magnet array; a projection of the three magnets along the first direction is located within each of the two yokes.

As an improvement, further including two elastic dampers spaced apart from each other; the mass block is rectangular; the two elastic dampers are arranged along a diagonal of the mass block; each of the two elastic dampers is sandwiched between the mass block and the side wall.

As an improvement, further including a flexible printed circuit (FPC) electrically connected to the coil; the FPC is disposed on the bottom plate; the side wall includes a notch; one end of the FPC is connected to the coil, the other end of the FPC extends outside the upper cover through the notch.

As an improvement, each of the two elastic members includes a first fixation arm fixed on the side wall, a second fixation arm fixed on the mass block, and an elastic arm connected the first fixation arm with the second fixation arm; the first fixation arm is opposite to the second fixation arm along the vibration direction; the elastic arm is in a U shape.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiments described hereby is only to explain this disclosure, not intended to limit this disclosure.

FIG. 1 is an isometric view of a linear vibration motor in accordance with an exemplary embodiment of the present disclosure.

FIG. 2 is an exploded view of the linear vibration motor in FIG. 1.

FIG. 3 is a cross-sectional view of the linear vibration motor taken along line A-A in FIG. 1.

FIG. 4 is an isometric view of the linear vibration motor in FIG. 1 removing an upper cover.

FIG. 5 is a schematic diagram of magnetic pole of two magnet assemblies of the linear vibration motor in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiments described hereby is only to explain the disclosure, not intended to limit the disclosure.

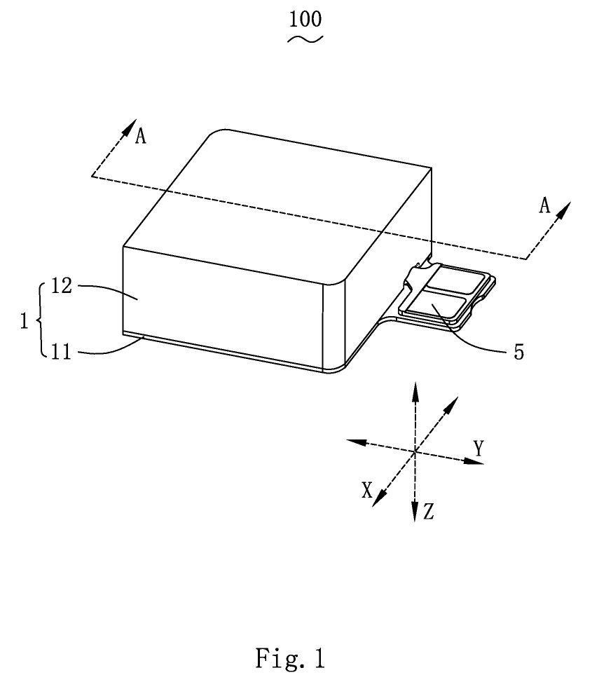

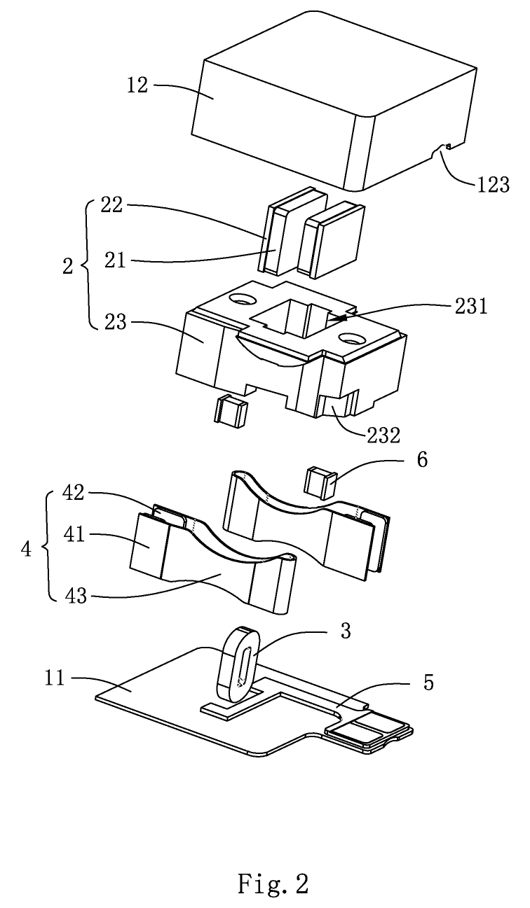

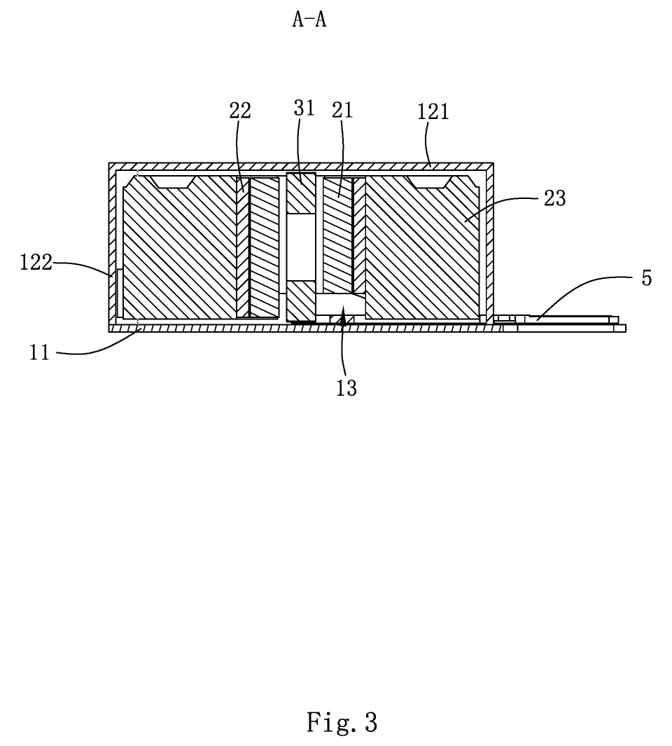

Please refer to FIGS. 1-4 together, a linear vibration motor 100 provided by an exemplary embodiment of the present disclosure includes a housing 1 having a receiving space 13, a vibrator 2 received in the receiving space 13, a stator 3 configured to drive the vibrator 2 to vibrate along a vibration direction, an elastic member 4 configured to suspend the vibrator 2 in the receiving space 13, and a flexible printed circuit (FPC) 5 disposed on the housing 1.

Specifically, the housing 1 includes a bottom plate 11 and an upper cover 12 disposed on the bottom plate 11 to form the receiving space 13. The upper cover 12 includes an upper plate 121 opposite to the bottom plate 11, and a side wall 122 connected the bottom plate 11 with the upper plate 12.

The vibrator 2 is received in the receiving space 13, and includes two magnet assemblies 21 spaced apart from each other along a first direction and arranged in parallel along a vibration direction, a mass block 23 including a through hole 231 penetrating thereon a second direction, and two yokes 22. The first direction, the vibration direction, and the second direction are orthogonal to each other. As shown in FIG. 1, the vibration direction is along the X direction, the first direction is along the Y axis, the second direction is along the Z axis. The two magnet assemblies 21 are mounted on the mass block 23 and received in the through hole 231. Each of two yokes 22 is sandwiched between a respective one of the two magnet assemblies 21 and the mass block 23.

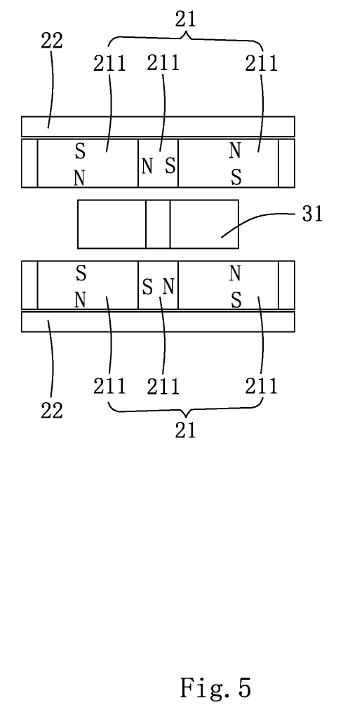

Specifically, each of the two magnet assemblies 21 includes three magnets 211 arranged successively along the vibration direction to form a Halbach magnet array. A projection of the three magnets 211 along the first direction is located within each of the two yokes 22. It should be noted that the three magnets 211 could be three individual permanent magnets, or integrally molded. As shown in FIG. 5, the central one of the three magnets 211 is magnetized along a direction perpendicular with the magnetization direction of the two side ones, and the two side magnets of the three magnets 211 are magnetized along opposite directions.

Moreover, the stator 3 is mounted on the bottom plate 11 and configured to drive the vibrator 2 to vibrate along the vibration direction. To be specific, the stator 3 includes a coil 31 located between the two magnet assemblies 21. The coil 31 is spaced apart from the two magnet assemblies 21 along the first direction. A winding plane of the coil 31 is parallel to the vibration direction. Two opposite ends of the coil 31 along the second direction are fixed on the bottom plate 11 and the upper plate 121 respectively. That is, the coil 31 1is glued to the bottom plat1 e and the upper plate 121.

Furthermore, a width of the coil 31 along the vibration direction is smaller than a width of each of the two magnet assemblies 21 along the vibration direction. Therefore, the coil 31 is wholly located inside the magnetics field of the two magnet assemblies 21, thereby increasing the Lorentz force therebetween and improving the drive efficiency of the linear vibration motor 100. Besides, the width of the coil 31 along the vibration direction is smaller than a height of the coil 31 along the second direction. In this manner, the coil 31 could be well-fixed to the housing 1.

Additionally, the number of the elastic member 4 is two. The two elastic members 4 are located at two opposite sides of the vibrator 2 along the vibration direction respectively. Two ends of each of the two elastic members 4 are fixed on the side wall 122 and the mass block 23 of the vibrator 2 respectively, thus suspending the vibrator 2 in the receiving space 13.

To be specific, each of the two elastic members 4 includes a first fixation arm 41 fixed on the side wall 122, a second fixation arm 42 fixed on the mass block 23, and an elastic arm 43 connected the first fixation arm 41 with the second fixation arm 42. The first fixation arm 41 is opposite to the second fixation arm 42 along the vibration direction. The elastic arm 43 is in a U shape.

Furthermore, the FPC 5 is electrically connected to the coil 31. The FPC 5 is disposed on the bottom plate 11. The side wall 122 includes a notch 123. One end of the FPC 5 is connected to the coil 31, the other end of the FPC 5 extends outside the upper cover 12 through the notch 123.

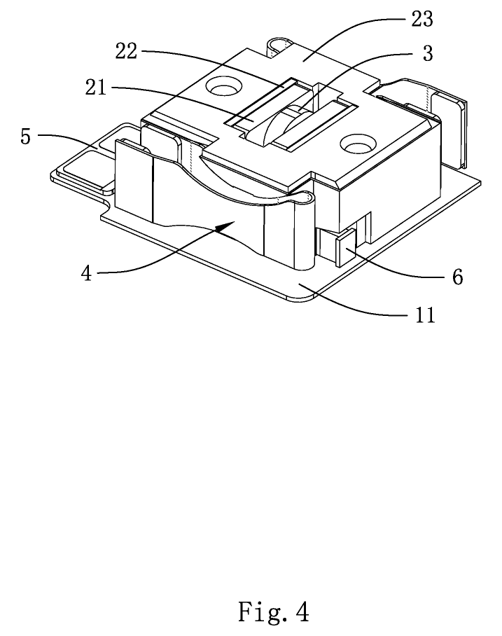

Furthermore, the linear vibration motor 100 includes two elastic dampers 6 spaced apart from each other. The mass block is rectangular. The two elastic dampers 6 are arranged along a diagonal of the mass block 23. Each of the two elastic dampers 6 is sandwiched between the mass block 23 and the side wall 122, thereby preventing the collision between the vibrator 2. As shown in FIG. 4, the mass block 23 includes an avoidance notch 232, and the elastic damper 6 is received in the avoidance notch 232. In one embodiment, the elastic damper 6 is chosen from one of the rubber, foam, or spring.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A linear vibration motor comprising:
a housing, comprising:
a bottom plate; and
an upper cover disposed on the bottom plate to form a receiving space;
a vibrator received in the receiving space, comprising two magnet assemblies spaced apart from each other and arranged in parallel;
a stator mounted on the bottom plate and configured to drive the vibrator to vibrate along a vibration direction, comprising a coil located between the two magnet assemblies; and
an elastic member configured to suspend the vibrator in the receiving space; wherein
the coil is spaced apart from each of the two magnet assemblies along a first direction perpendicular with the vibration direction; a winding plane of the coil is parallel to the vibration direction; two opposite ends of the coil along a second direction are fixed on the bottom plate and the upper cover respectively; the second direction is orthogonal to the vibration direction and the first direction.

2. The linear vibration motor as described in claim 1, wherein the upper cover comprises an upper plate opposite to the bottom plate along the second direction, and a side wall connected the bottom plate and the upper plate; the coil is sandwiched between the bottom plate and the upper plate.

3. The linear vibration motor as described in claim 2, wherein the coil is glued to the bottom plate and the upper plate.

4. The linear vibration motor as described in claim 1, wherein a width of the coil along the vibration direction is smaller than a width of each of the two magnet assemblies along the vibration direction.

5. The linear vibration motor as described in claim 1, wherein the width of the coil along the vibration direction is smaller than a height of the coil along the second direction.

6. The linear vibration motor as described in claim 2, wherein the number of the elastic member is two; the two elastic members are located at two opposite sides of the vibrator along the vibration direction respectively; two ends of each of the two elastic members are fixed on the vibrator and the side wall respectively.

7. The linear vibration motor as described in claim 2, wherein the vibrator further comprises a mass block including a through hole penetrating thereon along the second direction; the two magnet assemblies are mounted on the mass block and received in the through hole; two ends of each of the two elastic members are fixed on the mass block and the side wall respectively.

8. The linear vibration motor as described in claim 7, wherein the vibrator further comprises two yokes; each of two yokes is sandwiched between a respective one of the two magnet assemblies and the mass block.

9. The linear vibration motor as described in claim 8, wherein each of the two magnet assemblies comprises three magnets arranged successively along the vibration direction to form a Halbach magnet array; a projection of the three magnets along the first direction is located within each of the two yokes.

10. The linear vibration motor as described in claim 7, further comprising two elastic dampers spaced apart from each other; the mass block is rectangular; the two elastic dampers are arranged along a diagonal of the mass block; each of the two elastic dampers is sandwiched between the mass block and the side wall.

11. The linear vibration motor as described in claim 2, further comprising a flexible printed circuit (FPC) electrically connected to the coil; the FPC is disposed on the bottom plate; the side wall comprises a notch; one end of the FPC is connected to the coil, the other end of the FPC extends outside the upper cover through the notch.

12. The linear vibration motor as described in claim 11, wherein each of the two elastic members comprises a first fixation arm fixed on the side wall, a second fixation arm fixed on the mass block, and an elastic arm connected the first fixation arm with the second fixation arm; the first fixation arm is opposite to the second fixation arm along the vibration direction; the elastic arm is in a U shape.
